(19) United States
(12) Patent Application Publication
(10) Pub. No.: US 2026/0351800 A1
(43) Pub. Date: Nov. 5, 2026

(54) SEPARATOR FOR RECHARGEABLE BATTERY AND RECHARGEABLE BATTERY

(71) Applicant: SAMSUNG SDI CO., LTD., Yongin-si (KR)

(72) Inventors: Sang Hyuk CHO, Suwon-si (KR); Bo Ra SHIN, Suwon-si (KR); Jung Jin MOON, Suwon-si (KR); Se Yeong KANG, Suwon-si (KR); Dae Gi KIM, Suwon-si (KR); Sang Min LEE, Suwon-si (KR)

(73) Assignee: SAMSUNG SDI CO., LTD., Yongin-si (KR)

(21) Appl. No.: 19/656,386

(22) Filed: Apr. 23, 2026

(30) Foreign Application Priority Data
Apr. 30, 2025 (KR) 10-2025-0057223

(51) Int. Cl. H01M 50/491; H01M 50/417; H01M 50/431; H01M 50/446; H01M 50/449

(52) U.S. Cl. CPC H01M 50/491; H01M 50/417; H01M 50/431; H01M 50/446; H01M 50/449

(57) ABSTRACT

The present disclosure relates to a separator for a rechargeable battery and a rechargeable battery, wherein the separator includes a porous substrate; and a metal organic framework layer formed on at least one surface of the porous substrate, and at least a portion of the metal organic framework extends from at least one surface of the porous substrate.

### CROSS-REFERENCE TO RELATED APPLICATION

The present application claims priority and the benefit of Korean Patent Application No. 10-2025-0057223, filed on Apr. 30, 2025 in the Korean Intellectual Property Office, the entire disclosure of which is incorporated herein by reference.

### BACKGROUND

### 1. Field of the Disclosure

The present disclosure relates to a separator for a rechargeable battery, and a rechargeable battery including the separator.

### 2. Discussion of Related Art

With increasing presence of electronic devices such as, e.g., mobile phones, notebook computers, electric vehicles, and the like, that use batteries, the demand for secondary batteries having high energy density and high capacity is increasing. Therefore, improving the performance of rechargeable lithium batteries may be advantageous.

A rechargeable lithium battery typically includes a positive electrode and a negative electrode that contain an active material capable of the intercalation and deintercalation of lithium ions, and produces electric energy by oxidation and reduction reactions when the lithium ions are intercalated into and deintercalated from the positive electrode and the negative electrode.

The rechargeable lithium battery may include a separator between the positive electrode and the negative electrode.

### SUMMARY

The present disclosure is directed to a separator for a rechargeable battery that has low air permeability, low thermal shrinkage, high electrolyte absorption, and high ionic conductivity.

The present disclosure is also directed to a rechargeable battery including the above separator for a rechargeable battery.

According to an aspect of the present disclosure, there is provided a separator for a rechargeable battery.

The separator for a rechargeable battery includes a porous substrate and a metal organic framework (MOF) layer formed on at least one surface of the porous substrate, wherein at least a portion of the metal organic framework extends from at least one surface of the porous substrate.

According to another aspect of the present disclosure, there is provided a rechargeable battery.

The rechargeable battery includes a positive electrode, a negative electrode, and the separator for a rechargeable battery interposed between the positive electrode and the negative electrode.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which:

FIG. 1 is a cross-sectional view of a separator for a rechargeable battery, according to one example embodiment; and

FIG. 2, FIG. 3, FIG. 4 and FIG. 5 are schematic cross-sectional views of a rechargeable lithium battery, according to one example embodiment.

### DETAILED DESCRIPTION

Hereinafter, example embodiments of the present disclosure are described in detail. However, the example embodiments are provided as examples, the present disclosure is not limited thereto, and the present disclosure is only defined by the scope of the claims to be described below.

Hereinafter, example embodiments of the present disclosure are described in detail with reference to the attached drawings. Terms or words used in this specification and claims should not be interpreted as limited to their typical or dictionary meanings, but should be interpreted with meanings and concepts that conform to the technical idea of the present disclosure. Therefore, it should be understood that the example embodiments described in this specification and the configurations illustrated in the drawings are only some of the example embodiments of the present disclosure and do not represent all of the technical idea of the present disclosure, and various equivalents and modifications may exist at the time of filing this application. In addition, when used in this specification, “comprise” and “include” and/or “comprising” specify the presence of mentioned shapes, numbers, steps, operations, elements, components and/or groups thereof, and do not exclude the presence or addition of one or more other shapes, numbers, operations, elements, components and/or groups. Additionally, when describing example embodiments of the present disclosure, the phrase “may be” may include “one or more example embodiments of the present disclosure.”

Furthermore, to aid understanding of the disclosure, the attached drawings may not be drawn to scale, but rather, the dimensions of some components may be exaggerated. Furthermore, the same reference numbers may be assigned to the same components in different embodiments.

Unless otherwise specified herein, when a part such as a layer, film, region, plate, and the like, is described as being “on” another part, it includes not only the case where the part is “directly on” the other part but also the case where there is still another part therebetween.

Unless otherwise specified in this specification, anything indicated in the singular may also include the plural. Further, unless otherwise stated, “A or B” may mean “including A, including B, or including A and B.”

As used herein, the term “a combination thereof” may mean a mixture, laminate, composite, copolymer, alloy, blend, and reaction product of the components.

Here, the term “particle diameter D50” refers to the average particle diameter, which means the diameter of particles with a cumulative volume of 50% by volume in the particle size distribution. The particle size distribution may be measured by methods well known to those skilled in the art. For example, the particle size distribution may be measured using a particle size analyzer, a transmission electron micrograph, or a scanning electron micrograph. In another method, an D50 value may be obtained by measuring the particle diameter using a measuring device using dynamic light scattering, performing data analysis to count the number of particles for each particle size range, and then calculating the particle diameter therefrom. Alternatively, D50 may be measured using a laser diffraction method. For example, when measuring by laser diffraction, after the particles to be measured are dispersed in a dispersion medium, the particles may be introduced into a commercially available laser diffraction particle diameter measuring device (e.g., Microtrac MT 3000) and irradiated with ultrasonic waves of about 28 kHz at an output of 60 W, and the D50 based on 100% of the particle diameter distribution in the measurement device may be calculated.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

According to one example embodiment, the separator for a rechargeable battery may be used in a rechargeable lithium battery. However, the present disclosure is not limited thereto, and the separator may also be used in other metal-based rechargeable batteries other than rechargeable lithium batteries, such as, e.g., rechargeable sodium batteries.

In one example embodiment, the separator for a rechargeable battery includes a porous substrate, and a metal organic framework layer formed on at least one surface of the porous substrate.

The metal organic framework includes metal ions or metal ion clusters, and organic linkers, and is a compound in which the metals or metal ion clusters are connected through the organic linkers. The metal organic framework has pores on its surface and within its structure. Accordingly, the metal organic framework may facilitate the movement of ions, such as lithium cations (Li⁺), during battery charging and discharging, thereby enhancing ionic conductivity.

In the separator for a rechargeable battery, at least a portion of the metal organic framework is formed to extend from one surface of the porous substrate.

The above description that the metal organic framework is “formed to extend from” the substrate differs from a structure in which the metal organic framework layer is formed by merely applying the metal organic framework onto at least one surface of the porous substrate. Rather, the above description may mean that the metal organic framework is formed from the stem of the porous substrate, which constitutes part of the external surface or internal structure of the porous substrate.

Here, the “stem of the porous substrate” may refer to a specific region within the porous substrate that constitutes the initiation site for the growth of the metal organic framework. As is described below, the stem of the porous substrate may be formed through surface modification of the porous substrate.

Since the metal organic framework is formed to extend from one surface of the porous substrate, the separator may have low air permeability, low thermal shrinkage, high electrolyte absorption, and high ionic conductivity.

In separators in which a metal organic framework is applied onto one surface of the porous substrate, the metal organic framework may hinder or block the pores of the porous substrate, leading to issues such as increased air permeability and decreased ionic conductivity. In contrast, in the separator according to the present disclosure, the metal organic framework is formed to extend from one surface of the porous substrate. As a result, the metal organic framework may have a significantly smaller particle size, which helps reduce or suppress an increase in air permeability, and improves ionic conductivity.

In addition, in separators in which the metal organic framework is applied onto one surface of the porous substrate, the metal organic framework layer remains structurally independent from the porous substrate, and thus cannot restrain the thermal shrinkage of the porous substrate. On the other hand, in the separator according to the present disclosure, since the metal organic framework is formed to extend from one surface of the porous substrate, the metal organic framework may reduce or suppress the shrinkage of the porous substrate when exposed to heat, resulting in a low thermal shrinkage rate.

Additionally, since the metal organic framework is directly grown from one surface of the porous substrate, even when applied in cylindrical cells with large curvature, such as a jelly-roll structure, pore blockage is minimized, and ionic conductivity may be improved.

Moreover, in separators in which a metal organic framework is applied onto one surface of the porous substrate, surface hydroxyl groups and the porous structure may also contribute to improving the electrolyte absorption properties.

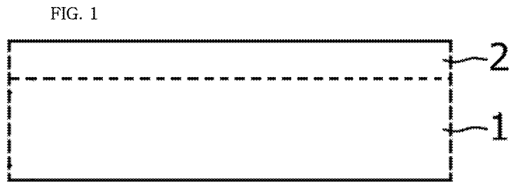

FIG. 1 is a cross-sectional view of a separator according to one example embodiment.

Referring to FIG. 1, the separator includes a porous substrate 1, and a metal organic framework layer 2 formed on one surface of the porous substrate 1. In FIG. 1, the dotted boundary between the porous substrate 1 and the metal organic framework layer 2 may indicate that the metal organic framework in the metal organic framework layer 2 is formed to extend from the porous substrate 1.

Hereinafter, the separator is described in detail.

### Porous Substrate

The porous substrate has a plurality of pores and may be or include a substrate commonly used in electrochemical devices. The porous substrate may be or include a polymer film formed from any one polymer such as or including at least one of, but not limited to, polyolefins such as polyethylene and polypropylene, polyesters such as polyethylene terephthalate and polybutylene terephthalate, polyacetal, polyamide, polyimide, polycarbonate, polyether ether ketone, polyaryletherketone, polyetherimide, polyamide-imide, polybenzimidazole, polyethersulfone, polyphenylene oxide, cyclic olefin copolymers, polyphenylene sulfide, polyethylene naphthalate, glass fiber, Teflon, and polytetrafluoroethylene, or a copolymer or a mixture of two or more thereof.

In one example, the porous substrate may be or include a polyolefin-based substrate including a polyolefin. The polyolefin-based substrate may exhibit desired or improved shut-down functionality, which may enhance battery safety. For example, the polyolefin-based substrate may be or include at least one of a polyethylene single-layer film, a polypropylene single-layer film, a polyethylene/polypropylene double-layer film, a polypropylene/polyethylene/polypropylene triple-layer film, and a polyethylene/polypropylene/polyethylene triple-layer film. In addition, the polyolefin-based resin may include a non-olefin resin in addition to the olefin resin, or may include a copolymer of olefin and non-olefin monomers.

In an example, the porous substrate may have hydroxyl groups exposed on its surface. The hydroxyl groups may enable the metal organic framework to extend from one surface of the porous substrate. The hydroxyl groups may be introduced through surface treatment of the porous substrate.

In an example, the porous substrate may have hydroxyl groups inside the porous substrate. The hydroxyl groups may enable the metal organic framework to be embedded inside the porous substrate. The hydroxyl groups may be introduced through surface treatment of the porous substrate.

The surface treatment is described in detail in the following section of the method of manufacturing the separator.

The porous substrate may have a thickness in a range of about 1 μm to about 40 μm, for example, 1 μm to 30 μm, 1 μm to 20 μm, or 5 μm to 15 μm.

In an example, the porous substrate may be or include a polyethylene-based resin film. The polyethylene-based resin film may facilitate the formation of hydroxyl groups on its surface through surface treatment. The hydroxyl groups may, e.g., facilitate the formation of a metal organic framework that extends from one surface of the porous substrate.

In an example, the polyethylene-based resin may have a weight average molecular weight of about 1,500,000 g/mol or less. Within the above range, the surface treatment of the porous substrate may be easier, and the thermal shrinkage during the formation of the metal organic framework layer may be reduced. For example, the polyethylene-based resin may have a weight average molecular weight in a range of about 1,000,000 g/mol to about 1,500,000 g/mol.

The “weight average molecular weight” may be determined as a polystyrene-converted value using, e.g., gel permeation chromatography.

### Metal Organic Framework Layer

The metal organic framework layer includes a metal organic framework that extends from one surface of the porous substrate.

The metal organic framework is formed to extend from one surface of the porous substrate. Accordingly, the metal organic framework layer may not include a binder for fixing the metal organic framework to the porous substrate. As a result, the separator may exhibit lower membrane resistance and avoid the challenge of increased air permeability caused by binder agglomeration. The binder may be or include a conventional binder that may be included in a coating layer of the separator.

The metal organic framework may be embedded inside the porous substrate. Therefore, when the porous substrate is exposed to heat, the metal organic framework may reduce or suppress the shrinkage of the porous substrate, thereby further reducing the thermal shrinkage of the separator.

The metal organic framework may extend from one surface of the porous substrate to form a single layer. Since the metal organic framework is directly grown from one surface of the porous substrate, the metal organic framework may form a thin two-dimensional film.

In an example, at least a portion of the metal organic framework may be aligned in one direction. In the separator, the metal organic framework layer is not formed by applying a composition containing a metal organic framework onto the porous substrate. Therefore, the metal organic framework in the metal organic framework layer may not be randomly distributed within the porous substrate, but may be aligned in one direction.

The metal organic framework may extend from one surface of the porous substrate, and may have a three-dimensional structure. Here, the three-dimensional structure may mean a regular hexagon or octagon.

In an example, at least a portion of the metal organic framework may be aligned in one direction. In the separator, the metal organic framework layer is not formed by applying a composition containing a metal organic framework onto the porous substrate. Therefore, the metal organic framework in the metal organic framework layer may not be randomly distributed within the porous substrate, but may be aligned in one direction.

The metal organic framework may have a window size in a range of about 0.3 nm to about 4 nm. Within the above range, the movement of lithium ions during battery charging and discharging may not be hindered, thereby improving the ionic conductivity of the separator. For example, the window size may be in a range of about 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4 nm, 0.4 nm to about 4 nm, or 0.4 nm to 1 nm.

Herein, the “window size” may refer to the size of pores formed inside the metal organic framework, which is composed of or includes metal ions and organic linkers.

The window size may be measured by a gas adsorption experiment, such as, e.g., the Brunauer-Emmett-Teller (BET) method.

When the metal organic framework is formed to extend from one surface of the porous substrate, the porous substrate may not be damaged, thereby reducing or preventing an increase in thermal shrinkage and a decrease in puncture strength of the separator.

The metal organic framework may have a particle diameter in a range of about 10 nm to about 200 nm. Within the above range, it may be possible to maintain high electrolyte absorption while reducing the thermal shrinkage of the separator. For example, the particle diameter may be 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200 nm, in a range of about 20 nm to about 100 nm.

The metal organic framework may include metal ions or metal ion clusters, and organic linkers, wherein the metal or metal ion clusters are connected by the organic linkers.

In an example, the metal may be or include a transition metal. For example, the transition metal may include at least one or more of Ni, Mg, Fe, Sc, Ti, V, Cr, Mn, Cu, Zn, Zr, Nb, Mo, Ru, Rh, Pd, Ag, Cd, Ta, Ir, Pt, Au, and Co.

For example, the metal may be Cu.

In an example, the organic linker may include at least one or more of a terephthalic acid-based linker, a benzene tricarboxylic acid-based linker, an imidazole-based linker, 2,3,6,7,10,11-hexahydroxytriphenylene (HHTP), 2,3,6,7,10,11-hexaiminotriphenylene (HITP), 2,4,6-tris(3,5-dicarboxylphenylamino)-1,3,5-triazine (H6TDPAT), and pyromellitic acid.

The terephthalic acid-based linker may include at least one of terephthalic acid, 2-aminoterephthalic acid, 2-sulfoterephthalate, 2,5-(dianilino)terephthalic acid, 2-hydroxyethylterephthalic acid, 2-(6-carboxypyridin-3-yl)terephthalic acid, 2-(2-carboxyphenoxy)terephthalic acid, or 2,5-dihydroxyterephthalic acid, but is not limited thereto.

The benzene tricarboxylic acid-based linker may be benzene-1,3,5-tricarboxylic acid (BTC).

The imidazole-based linker may include at least one of 2-methylimidazole, 2-ethylimidazole, 2-chloroimidazole, 4-bromoimidazole, 2-iodoimidazole, 4-iodoimidazole, 2-nitroimidazole, 2-chloromethylbenzimidazole, methylbenzimidazole, 2-aminobenzimidazole, 5-nitrobenzimidazole, or benzimidazole, but is not limited thereto.

For example, the organic linker may be one or more of a terephthalic acid-based linker and a benzene tricarboxylic acid-based linker.

The metal organic framework layer may have a thickness in a range of about 0.1 μm to about 3 μm, for example, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3 μm, 0.1 μm to 1 μm, or 0.5 μm to 1 μm. Within the above range, the metal organic framework layer may be used for a separator.

### Method of Manufacturing Separator

The method of manufacturing a separator may include surface-treating at least one surface of a porous substrate, and directly growing a metal organic framework from the surface-treated porous substrate.

### Surface Treatment of Porous Substrate

The porous substrate may be subjected to surface treatment to form a stem of the porous substrate.

Through surface treatment, the porous substrate may have hydroxyl groups exposed on its surface. Alternatively, the porous substrate may have hydroxyl groups inside the porous substrate through surface treatment.

The surface treatment of the porous substrate may include one or more of plasma treatment and alkaline treatment.

Through plasma treatment, a porous substrate with hydroxyl groups exposed on its surface may be manufactured.

The plasma treatment may use oxygen as a plasma gas. Oxygen may facilitate the formation of hydroxyl groups on the surface of the porous substrate.

In an example, the flow rate of the plasma gas may be controlled in the range of about 10 standard cubic centimeters per minute (sccm) to about 30 sccm, the power of the plasma gas may be controlled in the range of about 10 W to about 100 W, and the plasma treatment time may be controlled in the range of about 1 minute to about 30 minutes.

The alkaline treatment may be performed by immersing the porous substrate in a basic solution. The basic solution may easily penetrate not only the surface but also the interior of the porous substrate, thereby forming hydroxyl groups both on the surface and inside of the porous substrate.

In an example, the basic solution may be or include an aqueous solution of sodium hydroxide or potassium hydroxide. The treatment with the basic solution may be performed at room temperature.

### Direct Growth of Metal Organic Framework

The metal organic framework may be directly grown on the porous substrate by allowing a reaction solution containing a metal precursor and an organic linker to react with the surface-treated porous substrate.

The organic linker may be substantially the same as described above.

The metal precursor may be or include at least one of metal nitrates, metal ammonium salts, metal sulfates, metal halides, metal oxalate salts, metal acetate salts, and metal acetylacetonate salts. The metal may be or include at least one or more of Ni, Mg, Fe, Sc, Ti, V, Cr, Mn, Cu, Zn, Zr, Nb, Mo, Ru, Rh, Pd, Ag, Cd, Ta, Ir, Pt, Au, and Co.

In an example, the metal precursor may be or include one or more of copper nitrate trihydrate, zinc nitrate hexahydrate, zinc acetate dihydrate, zinc sulfate hexahydrate, iron nitrate hexahydrate, ferric chloride, calcium chloride, aluminum nitrate hexahydrate, and cobalt nitrate hexahydrate.

The reaction may be performed in one or more of an organic solvent and an aqueous solvent.

The organic solvent may be or include at least one or more of dimethyl carbonate, N-methylformamide, sulfolane (tetrahydrothiophene-1,1-dioxide), 3-methylsulfolane, N-butylsulfone, dimethyl sulfoxide, pyrrolidone (HEP), dimethylpiperidone (DMPD), N-methylpyrrolidone (NMP), N-methylacetamide, dimethylacetamide (DMAc), dimethylformamide (DMF), diethylacetamide (DEAc), dipropylacetamide (DPAc), ethanol, propanol, butanol, hexanol, ethylene glycol, tetrachloroethylene, propylene glycol, toluene, turpentine, methyl acetate, ethyl acetate, petroleum ether, acetone, cresol, and glycerol, and for example dimethylformamide (DMF).

The aqueous solvent may be water.

The reaction may be performed by immersing the surface-treated porous substrate into a reaction solution containing the metal precursor and the organic linker, and then adding a metal catalyst or applying heat. The heating time and temperature may be adjusted depending on the concentration and/or type of the metal precursor and organic linker.

### Rechargeable Lithium Battery

According to one example embodiment, the rechargeable lithium battery includes the separator for a rechargeable lithium battery, a positive electrode, and a negative electrode.

The separator for rechargeable lithium battery refers to the description described above. The separator for rechargeable lithium battery may be positioned between the positive electrode and the negative electrode.

### Positive Electrode

A positive electrode for a rechargeable lithium battery may include a current collector, and a positive electrode active material layer on the current collector. The positive electrode active material layer may include a positive electrode active material and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}Dₑ (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of each of the binder and the conductive material may independently be in a range of about 0.5 wt % to about 5 wt %, respectively, based on 100 wt % of the positive electrode active material layer.

The binder attaches the positive electrode active material particles to each other, and also attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause an adverse chemical change (e.g., does not cause an undesirable chemical change in the rechargeable lithium battery) and that conducts electrons can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in a form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include a range of about 90 wt % to about 99 wt % of the negative electrode active material, a range of about 0 wt % to about 5 wt % or about 0.5 wt % to about 5 wt % of the binder, and a range of about 0 wt % to about 5 wt % or about 0.5 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may also attach the negative electrode active material to the current collector.

The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause an adverse chemical change (e.g., does not cause an undesirable chemical change in the rechargeable lithium battery) and that conducts electrons can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in a form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone, or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

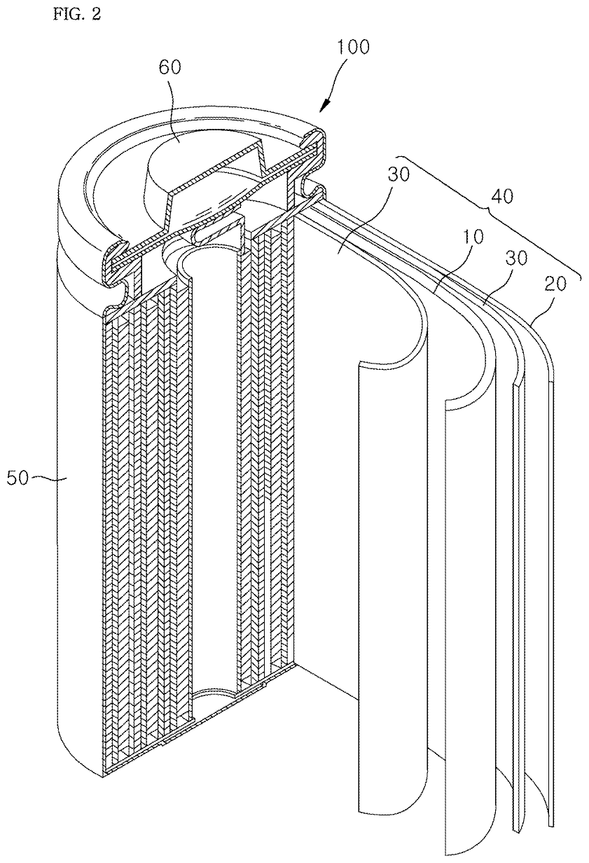

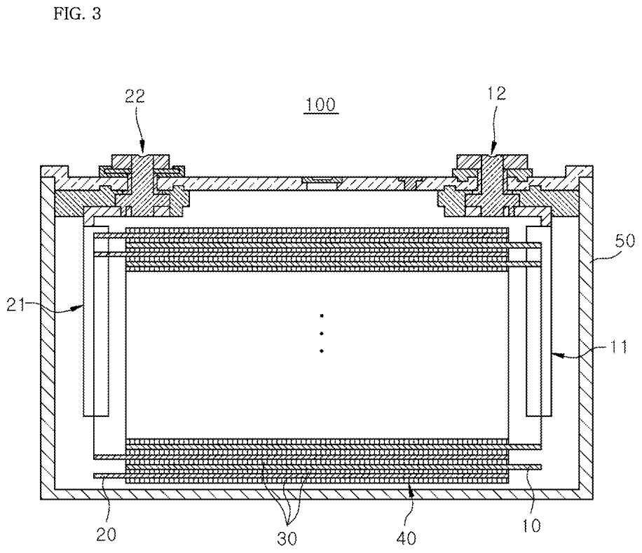

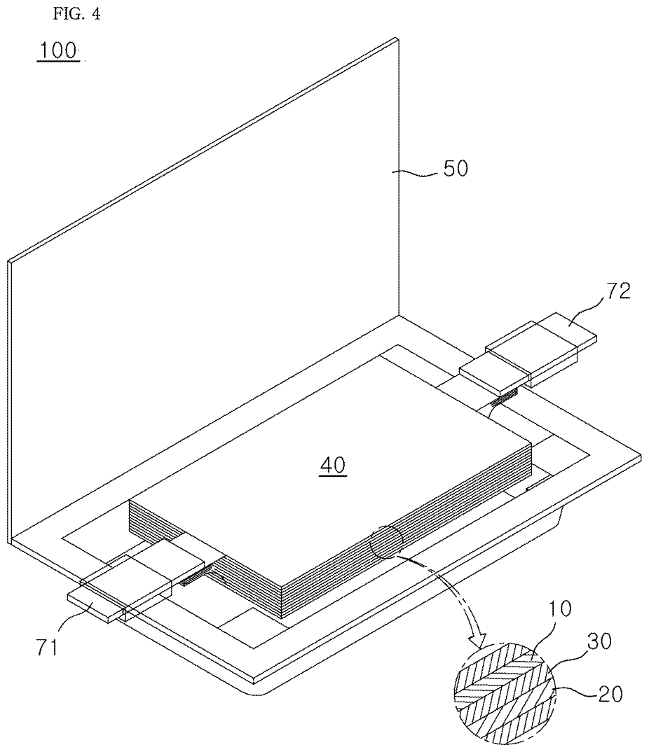

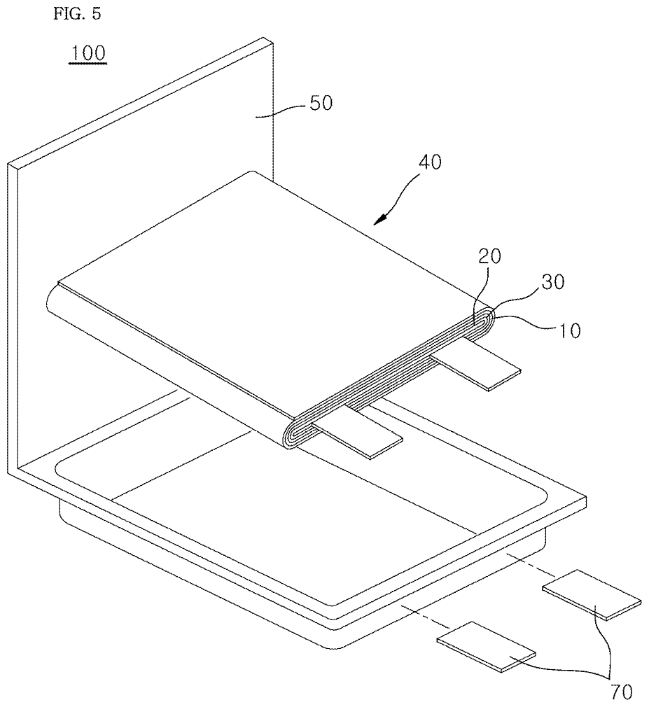

FIG. 2 to FIG. 5 are schematic views illustrating a rechargeable lithium battery according to an example embodiment. FIG. 2 shows a cylindrical battery, FIG. 3 shows a prismatic battery, and FIG. 4 and FIG. 5 show pouch-type batteries. Referring to FIG. 2 to FIG. 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 4 and FIG. 5, the rechargeable lithium battery 100 may include an electrode tab 70 illustrated in FIG. 5, or, for example, a positive electrode tab 71 and a negative electrode tab 72 illustrated in FIG. 4, the electrode tabs 70/71/72 forming an electric path for inducing the current formed in the electrode assembly 40 to the outside of the battery 100.

The rechargeable lithium battery according to an example embodiment may be applicable to, e.g., automobiles, mobile phones, and/or various types of electric devices, as non-limiting examples.

Hereinafter, the examples and comparative examples of the present disclosure are described. However, the following examples are only illustrative examples of the present disclosure, and the present disclosure is not limited to the following examples.

### Example 1

A polyethylene-based resin film (weight average molecular weight: 1,000,000 g/mol, thickness: 8 μm), as a porous substrate, was immersed in a 10% aqueous sodium hydroxide solution and left to stand for 2 hours, and then washed with distilled water to surface treat the polyethylene-based resin film (Step I).

After dissolving 44 mmol of terephthalic acid and 40 mmol of 1,6-dibromodecane in 200 mL of dimethylformamide, the surface-treated polyethylene-based resin film was immersed in this solution at room temperature and maintained for 3 hours (Step II).

After dissolving 40 mmol of copper nitrate trihydrate (Cu(NO₃)₂·3H₂O) in 200 mL of tetrahydrofuran, this solution was added to the mixture from Step II and allowed to react for 5 hours to manufacture a separator.

### Example 2

The same polyethylene-based resin film used in Step (I) of Example 1 was surface-treated.

After dissolving 40 mmol of benzene-1,3,5-tricarboxylic acid in 200 mL of ethanol, the surface-treated polyethylene-based resin film was immersed in this solution at room temperature and maintained for 3 hours (Step II).

After dissolving 40 mmol of copper nitrate trihydrate (Cu(NO₃)₂·3H₂O) in 200 mL of tetrahydrofuran, this solution was added to the mixture from Step II and allowed to react for 5 hours to manufacture a separator.

### Example 3

A separator was manufactured in the same manner as in Example 1, except that the reaction time was changed to 1 hour.

### Example 4

A separator was manufactured in the same manner as in Example 1, except that the reaction time was changed to 10 hours.

### Example 5

A separator was manufactured in the same manner as in Example 1, except that the reaction time was changed to 24 hours.

### Example 6

A polyethylene-based resin film (weight-average molecular weight: 1,000,000 g/mol, thickness: 8 μm), as a porous substrate, was surface treated using oxygen as a plasma gas, with an oxygen gas flow rate of 20 sccm and a power of 50 W for 5 minutes, to manufacture a surface-treated polyethylene-based resin film (Step I).

After dissolving 44 mmol of terephthalic acid and 40 mmol of 1,6-dibromodecane in 200 mL of dimethylformamide, the surface-treated polyethylene-based resin film was immersed in this solution and maintained for 3 hours (Step II).

After dissolving 40 mmol of copper nitrate trihydrate (Cu(NO₃)₂·3H₂O) in 200 mL of tetrahydrofuran, this solution was added to the mixture from Step II and allowed to react for 5 hours to manufacture a separator.

### Comparative Example 1

A polyethylene-based resin film (weight-average molecular weight: 1,000,000 g/mol, thickness: 8 μm) was used as a porous substrate. A composition for a coating layer was prepared by mixing a copper terephthalate MOF in water as an aqueous solvent. The composition for a coating layer was applied onto one surface of the polyethylene-based resin film and dried to manufacture a separator.

### Comparative Example 2

A polyethylene-based resin film (weight-average molecular weight: 1,000,000 g/mol, thickness: 8 μm), which was the same porous substrate used in Example 1, was used as the separator.

The physical properties of the separators manufactured in Examples and Comparative Examples were evaluated, and the results are shown in Table 1 below.

(1) Air Permeability (Units: sec/100 cc)

Air permeability was measured as the time (units: sec) it takes for 100 cc of air to pass through the separator using a measurement device (EG01-55-1MR, Asahi Seiko Co., Ltd.).

### Settings for Air Permeability Measurement Device:

Measurement pressure: 0.5 kg/cm², Cylinder pressure: 2.5 kg/cm², Setting time: 10 seconds

### (2) Electrolyte Absorption Rate (Units: %)

The separators of Examples and Comparative Examples were cut into 8 cm×8 cm samples, and the initial weight W1 of each sample was measured. Each sample was then fully immersed in an electrolyte (1.5 M LiPF₆ dissolved in a mixture of ethylene carbonate, ethyl methyl carbonate, and dimethyl carbonate in a volume ratio of 30:50:20 at 25 °C) and left to stand for one day. After immersion, the samples were removed and their weight W2 was measured. The electrolyte absorption rate was calculated using the following formula: (W2/W1)×100.

(3) Ionic Conductivity (Units: mS/cm)

The separators manufactured in Examples and Comparative Examples were immersed in an electrolyte (1.5 M LiPF₆ dissolved in a mixture of ethylene carbonate, ethyl methyl carbonate, and dimethyl carbonate in a volume ratio of 30:50:20 at 25 °C). The electrolyte-impregnated separators were then placed between aluminum foil electrodes with lead tabs, sealed in aluminum packs, and assembled into test cells. Ionic conductivity was measured using an AC impedance method (measurement frequency of 100 kHz).

### (4) Thermal Shrinkage Rate (Units: %)

The separators of Examples and Comparative Examples were cut into 8 cm×8 cm samples. After drawing a 5 cm×5 cm square on the surface of each sample, the samples were sandwiched between paper or alumina powder and placed in an oven at 130 °C for 1 hour. After heating, the samples were removed, and the dimensions of the sides of the drawn square were measured. The shrinkage rates in the machine direction MD and transverse direction TD were calculated based on these measurements. The shrinkage rate was calculated according to Equation 1 below.

Shrinkage rate=(L0−L1)/L0×100. Equation 1:

L0 is the initial length of the separator, and L1 is the length of the separator after leaving it at 130 °C for 1 hour.

### (5) Puncture Strength (Units: gf)

Ten specimens were prepared by cutting each separator of Examples and Comparative Examples at ten different locations into pieces with a width (MD) of 50 mm×length (TD) of 50 mm. Each specimen was placed over a 10 cm diameter opening using a GATO Tech G5 device, and the puncture force was measured while pressing with a 1 mm probe. Each specimen was tested three times, and the average puncture strength was calculated.

TABLE 1

| | | Example | Example | Example | Example | Example | Example | Comparative | Comparative |
|---|---|---|---|---|---|---|---|---|---|
| | | 1 | 2 | 3 | 4 | 5 | 6 | Example 1 | Example 2 |
| Window size (nm) | | 0.8 | 0.8 | 0.3 | 0.8 | 0.8 | 0.8 | 0.8 | — |
| Particle size (nm) | | 50 | 50 | 50 | 10 | 200 | 50 | 50 | — |
| Surface modification | | NaOH | NaOH | NaOH | NaOH | NaOH | Plasma | — | — |
| Thickness | Substrate | 8 | 8 | 8 | 8 | 8 | 8 | 8 | 8 |
| (μm) | MOF | 1 | 1 | 1 | 0.5 | 1 | 0.5 | 1 | 0 |
| | layer | | | | | | | | |

| | | | | | | | | |
|---|---|---|---|---|---|---|---|---|
| Air permeability | 88 | 98 | 85 | 85 | 88 | 85 | 96 | 84 |
| Electrolyte absorption | 134 | 108 | 109 | 94 | 104 | 71 | 108 | 64 |
| rate | | | | | | | | |
| Ionic conductivity | 1.24 | 1.20 | 1.02 | 0.84 | 1.23 | 0.89 | 0.99 | 0.82 |
| Thermal shrinkage | 1/0 | 8/10 | 2/3 | 11/13 | 2/2 | 7/8 | 3/3 | 12/20 |
| rate | | | | | | | | |
| Puncture strength | 491 | 434 | 482 | 476 | 432 | 478 | 479 | 475 |

As shown in Table 1 above, the separators of Examples exhibited low air permeability, low thermal shrinkage, high electrolyte absorption, and high ionic conductivity.

According to one example embodiment, a separator for a rechargeable battery that has low air permeability, low thermal shrinkage, high electrolyte absorption, and high ionic conductivity is provided.

Although the example embodiments of the present disclosure have been described above, the present disclosure is not limited thereto, various modifications are possible within the scope of the claims, detailed description, and attached drawings of the disclosure, and these modifications also fall within the scope of the present disclosure.

What is claimed is:

1. A separator for a rechargeable battery, the separator comprising:
a porous substrate; and
a metal organic framework (MOF) layer formed on at least one surface of the porous substrate,
wherein at least a portion of the metal organic framework extends from at least one surface of the porous substrate.

2. The separator of claim 1, wherein the porous substrate comprises a polyethylene-based resin film.

3. The separator of claim 1, wherein the porous substrate has hydroxyl groups on a surface thereof.

4. The separator of claim 1, wherein the metal organic framework extending from at least one surface of the porous substrate forms a single layer.

5. The separator of claim 4, wherein at least a portion of the metal organic framework is aligned in one direction.

6. The separator of claim 1, wherein the metal organic framework extending from at least one surface of the porous substrate has a three-dimensional structure.

7. The separator of claim 6, wherein at least a portion of the metal organic framework is aligned in one direction.

8. The separator of claim 1, wherein the metal organic framework has a window size in a range of about 0.3 nm to about 4 nm.

9. The separator of claim 1, wherein the metal organic framework has a particle diameter in a range of about 10 nm to about 200 nm.

10. The separator of claim 1, wherein the metal organic framework is embedded inside the porous substrate.

11. The separator of claim 10, wherein hydroxyl groups are present inside the porous substrate.

12. The separator of claim 1, wherein the metal organic framework layer further comprises a metal organic framework embedded inside the porous substrate.

13. The separator of claim 12, wherein the porous substrate comprises hydroxyl groups.

14. The separator of claim 1, wherein a particle diameter of the metal organic framework is smaller than a pore size of the porous substrate.

15. The separator of claim 1, wherein:
the metal organic framework comprises a metal or a metal cluster, and an organic linker,
the metal comprises copper, and
the organic linker comprises one or more of a terephthalic acid-based linker and a benzene tricarboxylic acid-based linker.

16. The separator of claim 1, wherein the porous substrate comprises a polyolefin-based resin with a weight average molecular weight of about 1,500,000 g/mol or less.

17. The separator of claim 1, wherein the metal organic framework layer does not include a binder.

18. The separator of claim 1, wherein the metal organic framework is directly grown from the porous substrate.

19. A rechargeable battery comprising:
a positive electrode;
a negative electrode; and
the separator for a rechargeable battery according to claim 1 interposed between the positive electrode and the negative electrode.
